(19) United States
(12) Patent Application Publication
(10) Pub. No.: US 2012/0260028 A1
(43) Pub. Date: Oct. 11, 2012

(54) SEMICONDUCTOR MEMORY SYSTEM HAVING SEMICONDUCTOR MEMORY DEVICES OF VARIOUS TYPES AND A CONTROL METHOD FOR THE SAME

(75) Inventors: Hyun Woong Lee, Yongin Si (KR); Young Goan Kim, Seoul (KR)

(73) Assignee: NOVACHIPS CO., LTD., Seongnam-si (KR)

(21) Appl. No.: 13/517,295

(22) PCT Filed: Jan. 12, 2011
(86) PCT No.: PCT/KR11/00228

§ 371 Date: Jun. 20, 2012

(30) Foreign Application Priority Data
Jan. 15, 2010 (KR) 10-2010-0003922

(51) Int. Cl. G06F 12/02; G06F 12/00

(52) U.S. Cl. 711/103; 711/154; 711/E12.001; 711/E12.008

(57) ABSTRACT

Disclosed are a semiconductor memory system having semiconductor memory devices of various types and a control method for the same. A semiconductor memory system according to an embodiment of the present invention comprises a plurality of semiconductor memory devices; and a memory controller for controlling the read-out of data programs for the plurality of semiconductor memory devices and data from the plurality of semiconductor memory devices, wherein at least two of the plurality of semiconductor memory devices differ from each other in terms of one or more of the following: the number of bits of data programmed in memory cells, the degree of integration, the manufacturer, whether they are synchronized, and whether or not encoded data is stored.

### TECHNICAL FIELD

The present invention relates to a semiconductor memory system and a control method for the same, and more particularly to a semiconductor memory system, which can include different types of flash memory devices in one semiconductor memory system, and a control method for the same.

### BACKGROUND ART

Flash memory devices, the demand for which has increased due to advantages such as high capacity and high speed, have been developed in different types. However, each of the different types of flash memory devices operates in an individual control scheme.

### DETAILED DESCRIPTION OF THE INVENTION

### Technical Problem

Therefore, a technical object that the present invention intends to achieve is to provide a semiconductor memory system, which can include different types of flash memory devices in one system, and a control method for the same.

### Technical Solution

In order to accomplish the above-mentioned objects, in accordance with an aspect of the present invention, there is provided a semiconductor memory system. The semiconductor memory system includes: multiple semiconductor memory devices; an information storage unit for storing control information of each semiconductor memory device according to a difference between the multiple semiconductor memory devices; and multiple channel control units each for controlling an operation of programming data into a semiconductor memory device connected to a corresponding channel, or an operation of reading data therefrom, according to control information received from the information storage unit.

The semiconductor memory devices may correspond to NAND (NOT AND) flash memory devices. In this case, the information storage unit may store control information depending on a difference in at least one of a manufacturer, a degree of integration, data characteristics (normal data/security data), and whether the semiconductor memory devices are synchronized, between the semiconductor memory devices.

The information storage unit may include control information depending on a difference in at least two of the number of bits of data programmed in a memory cell, a degree of integration, a manufacturer, whether the semiconductor memory devices are synchronized, and whether encrypted data is stored, between the semiconductor memory devices. In this case, each of the multiple channel control units may include: an interface controller for performing interfacing of data transmitted or received through a corresponding channel according to the control information stored in the information storage unit; and a channel controller for controlling the operation of programming the data into the semiconductor memory device connected to the corresponding channel, or the operation of reading the data therefrom, according to the control information received from the information storage unit.

The channel control unit may store a result of an operation performed for each corresponding channel in the information storage unit. In this case, each of the channel control units may perform error correction code/error detection code (ECC/EDC) processing, which adapts to the semiconductor memory device connected to the corresponding channel, according to the control information received from the information storage unit.

### Advantageous Effects

A semiconductor memory system and a control method for the same, according to the present invention have an advantage in that they can build a semiconductor memory system which adapts to consumer demand by combining different types of flash memory devices into one system. For example, it is possible to mass-produce semiconductor memory systems optimized for consumers' demands for the unit price of a product and the performance thereof.

### BRIEF DESCRIPTION OF THE DRAWINGS

In order to more fully understand the drawings referred to in the detailed description of the present invention, a brief description of each drawing is provided.

FIG. 1 to FIG. 7 are block diagrams showing configurations of flash memory systems according to first to seventh embodiments of the present invention, respectively.

FIG. 8 is a block diagram showing the configuration of a memory controller shown in each of FIG. 1 to FIG. 7.

FIG. 9 is a block diagram showing another example of the memory controller shown in FIG. 8.

FIG. 10 is a block diagram showing a more detailed configuration of a channel control unit shown in FIG. 8.

FIG. 11 is a view for explaining the operation of the memory controller shown in FIG. 8.

FIG. 12 is a block diagram showing the configuration of an SSD (Solid State Drive) and that of a computer system including the SSD, according to an exemplary embodiment of the present invention.

### MODE FOR CARRYING OUT THE INVENTION

To fully understand the present invention, the advantages in the operation of the present invention, and the objects accomplished by the implementations of the present invention, reference should be made to the accompanying drawings illustrating exemplary embodiments of the present invention and the contents described in the accompanying drawings.

Hereinafter, exemplary embodiments of the present invention will be described in detail with reference to the accompanying drawings. The same elements will be designated by the same reference numerals although they are shown in different drawings.

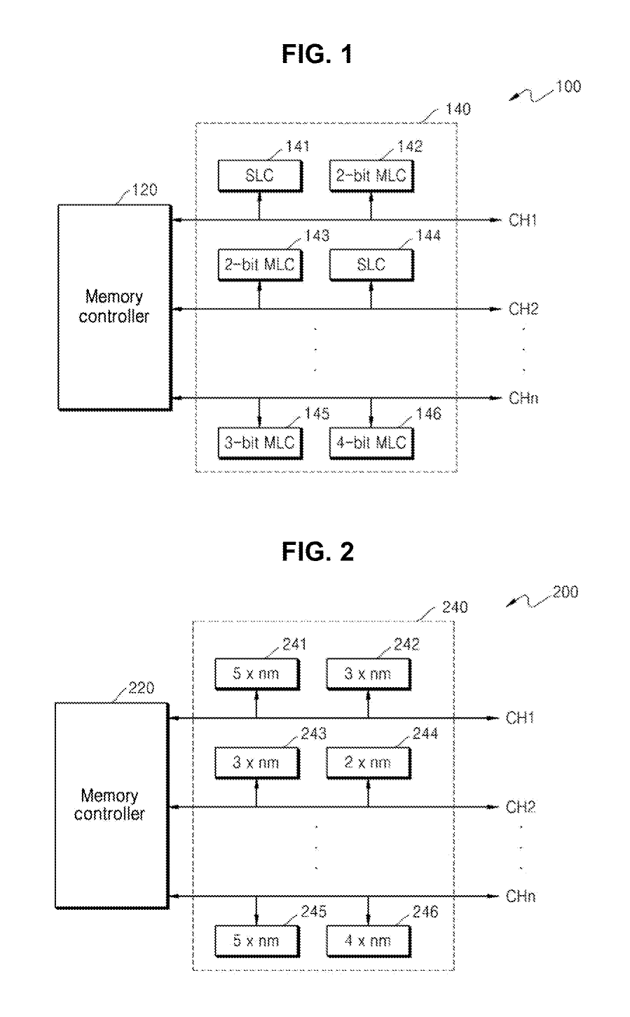

FIG. 1 is a block diagram showing the configuration of a semiconductor memory system according to a first embodiment of the present invention.

Referring to FIG. 1, a semiconductor memory system 100 according to a first embodiment of the present invention includes a memory controller 120, channels CH1, CH2, . . . , and CHn (n is a natural number equal to or greater than 3), and flash memory devices 140.

The memory controller 120 controls an operation of writing a program to the flash memory devices 140 and an operation of reading data from the flash memory devices 140. The configuration and the operation of the memory controller 120 will be described in detail below.

The channels CH1, CH2, . . . , and CHn connect the memory controller 120 to the flash memory devices 140. The channels CH1, CH2, . . . , and CHn may electrically or optically connect the memory controller 120 to the flash memory devices 140.

At least two of the flash memory devices 140 as shown in FIG. 1 may differ in the number of bits of data programmed in each memory cell, therebetween. For example, as shown in FIG. 1, a first flash memory device 141 may be a single-level cell flash memory device where only one bit is programmed in each memory cell, and a second flash memory device 142 may be a multi-level cell flash memory device where multiple bits are programmed in each memory cell. Particularly, the second flash memory device 142 may be a 2-bit multi-level cell flash memory device where two bits are programmed in each memory cell. Also, the semiconductor memory system 100 as shown in FIG. 1 may include flash memory devices 145 and 146 where three or more bits are programmed in each memory cell. Although not shown in FIG. 1, the semiconductor memory system 100 may include a multi-level cell flash memory device where five or more bits are programmed in each memory cell. The semiconductor memory system 100 may include the same type of flash memory devices, such as the first flash memory device 141 and a fourth flash memory device 144, or the second flash memory device 142 and a third flash memory device 143.

Although FIG. 1 shows that two flash memory devices are installed in each of the channels CH1, CH2, . . . , and CHn, the present invention is not limited to this configuration. Each of the channels CH1, CH2, . . . , and CHn may connect one flash memory device, or three or more flash memory devices. The flash memory devices 140 as shown in FIG. 1 may be NAND (NOT AND) flash memory devices. The number of flash memory devices connected to each channel as shown in the following drawings is only an illustrative example. Also, flash memory devices which will be described below may be NAND flash memory devices if there is no special explanation.

FIG. 2 is a block diagram showing the configuration of a semiconductor memory system according to a second embodiment of the present invention.

Referring to FIG. 2, a semiconductor memory system 200 according to a second embodiment of the present invention includes a memory controller 220, flash memory devices 240, and channels CH1, CH2, . . . , and CHn, which connect the memory controller 220 to the flash memory devices 240, similarly to the semiconductor memory system 100 as shown in FIG. 1.

However, at least two of the flash memory devices 240 as shown in FIG. 2 may differ in the degree of integration therebetween. For example, as shown in FIG. 2, a first flash memory device 241 may be a flash memory device produced by using a 5-nanometer process, and a second flash memory device 242 may be a flash memory device produced by using a 3-nanometer process. Also, the semiconductor memory system 200 as shown in FIG. 2 may include a fourth flash memory device 244 produced by using a 2-nanometer process and a sixth flash memory device 246 produced by using a 4-nanometer process. Although not shown in FIG. 2, the semiconductor memory system 200 may also include a flash memory device produced in such a manner that it has another degree of integration. The semiconductor memory system 200 may include the same type of flash memory devices, such as the first flash memory device 241 and a fifth flash memory device 245, or the second flash memory device 242 and a third flash memory device 243.

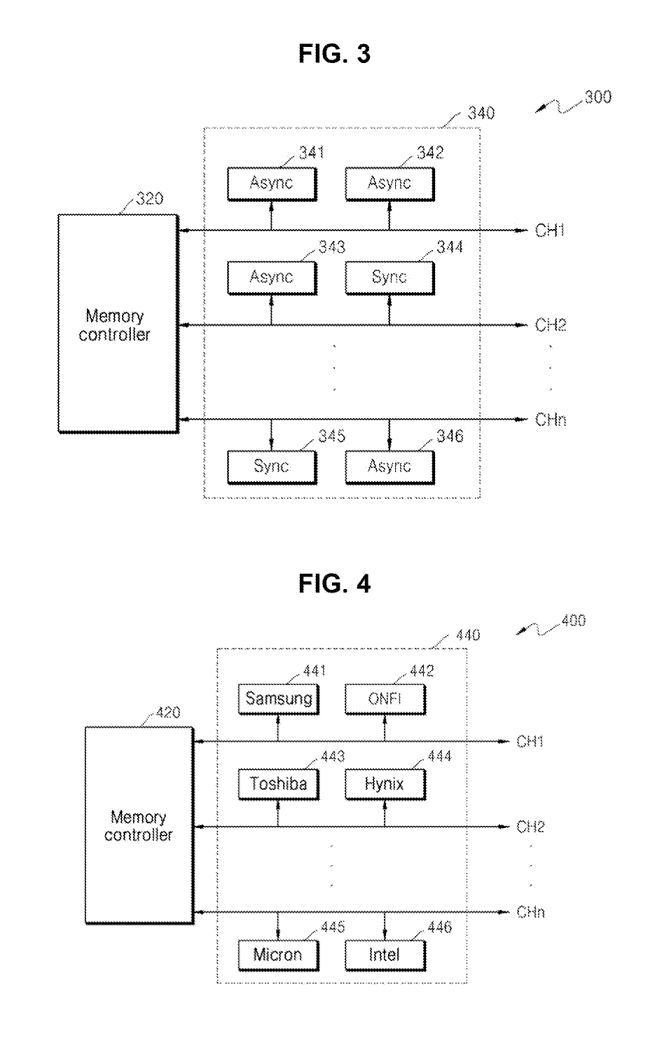

FIG. 3 is a block diagram showing the configuration of a semiconductor memory system according to a third embodiment of the present invention.

Referring to FIG. 3, a semiconductor memory system 300 according to a third embodiment of the present invention includes a memory controller 320, flash memory devices 340, and channels CH1, CH2, . . . , and CHn, which connect the memory controller 320 to the flash memory devices 340, similarly to the semiconductor memory system 100 as shown in FIG. 1.

However, the semiconductor memory system 300 as shown in FIG. 3 may simultaneously include a synchronous flash memory device and an asynchronous flash memory device. For example, as shown in FIG. 3, a first flash memory device 341, a second flash memory device 342, a third flash memory device 343 and a sixth flash memory device 346 may be asynchronous flash memory devices, whereas a fourth flash memory device 344 and a fifth flash memory device 345 may be synchronous flash memory devices.

FIG. 4 is a block diagram showing the configuration of a semiconductor memory system according to a fourth embodiment of the present invention.

Referring to FIG. 4, a semiconductor memory system 400 according to a fourth embodiment of the present invention includes a memory controller 420, flash memory devices 440, and channels CH1, CH2, . . . , and CHn, which connect the memory controller 420 to the flash memory devices 440, similarly to the semiconductor memory system 100 as shown in FIG. 1.

However, the semiconductor memory system 400 as shown in FIG. 4 may simultaneously include flash memory devices manufactured by different manufacturers. For example, as shown in FIG. 4, a first flash memory device 441 may be a product of Samsung, a second flash memory device 442 may be a product of ONFI, and a third flash memory device 443 may be a product of Toshiba. Also, a fourth flash memory device 444 may be a product of Hynix, a fifth flash memory device 445 may be a product of Micron, and a sixth flash memory device 446 may be a product of Intel. Further, although not shown in FIG. 4, the semiconductor memory system 400 may also include flash memory devices of other manufacturers.

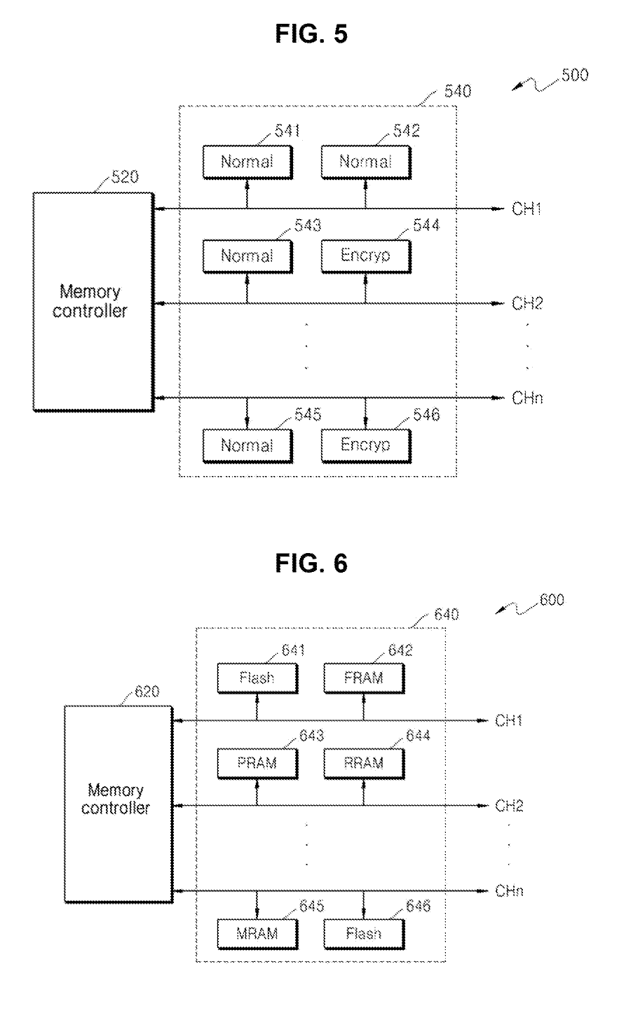

FIG. 5 is a block diagram showing the configuration of a semiconductor memory system according to a fifth embodiment of the present invention.

Referring to FIG. 5, a semiconductor memory system 500 according to a fifth embodiment of the present invention includes a memory controller 520, flash memory devices 540, and channels CH1, CH2, . . . , and CHn, which connect the memory controller 520 to the flash memory devices 540, similarly to the semiconductor memory system 100 as shown in FIG. 1.

However, the semiconductor memory system 500 as shown in FIG. 5 may simultaneously include a flash memory device for storing normal data and a flash memory device for storing security data. For example, as shown in FIG. 5, a first flash memory device 541, a second flash memory device 542, a third flash memory device 543 and a fifth flash memory device 545 may be flash memory devices for storing normal data. A fourth flash memory device 544 and a sixth flash memory device 546 may be flash memory devices for storing security data.

FIG. 6 is a block diagram showing the configuration of a semiconductor memory system according to a sixth embodiment of the present invention.

Referring to FIG. 6, a semiconductor memory system 600 according to a sixth embodiment of the present invention includes a memory controller 620, memory devices 640, and channels CH1, CH2, . . . , and CHn, which connect the memory controller 620 to the memory devices 640.

The semiconductor memory system 600 as shown in FIG. 6 may simultaneously include a flash memory device and a nonvolatile memory device which is not a flash memory device. For example, as shown in FIG. 6, a first memory device 641 and a sixth memory device 646 may be flash memory devices, a second memory device 642 may be an FRAM (Ferroelectric Random Access Memory), and a third memory device 643 may be a PRAM (Phase-change Random Access Memory). Also, a fourth memory device 644 may be an RRAM (Resistive Random Access Memory), and a fifth memory device 645 may be an MRAM (Magnetoresistive Random Access Memory). Further, although not shown in FIG. 6, the semiconductor memory system 600 may include a nonvolatile memory device of another type.

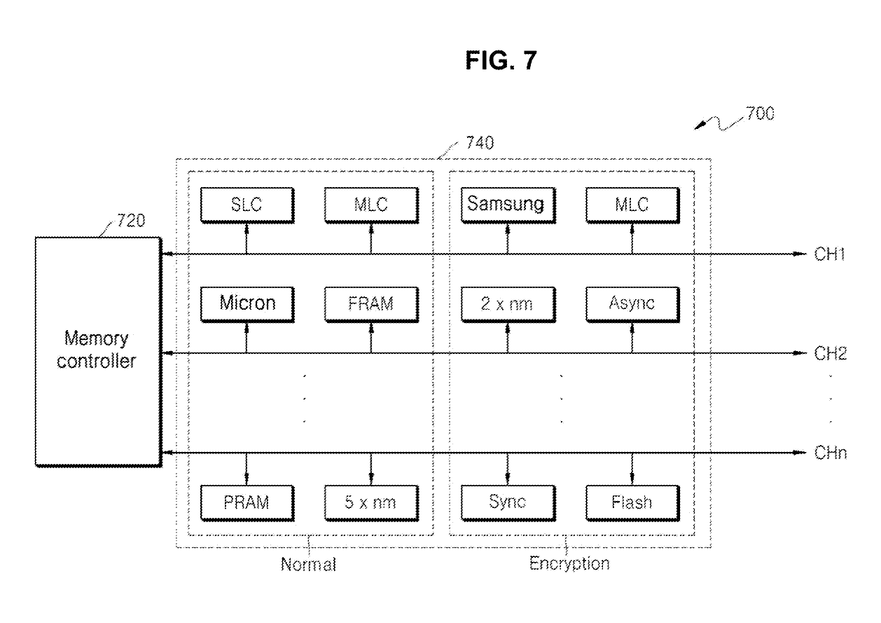

FIG. 7 is a block diagram showing the configuration of a semiconductor memory system according to a seventh embodiment of the present invention.

Referring to FIG. 7, a semiconductor memory system 700 according to a seventh embodiment of the present invention may simultaneously include the different types of memory devices as shown in FIG. 1 to FIG. 6. For example, the semiconductor memory system 700 as shown in FIG. 7 may simultaneously include a single-level cell flash memory device, a multi-level cell flash memory device, a flash memory device of Samsung, a flash memory device of Micron, a flash memory device produced by using a 5-nanometer process, and a flash memory device produced by using a 2-nanometer process, as memory devices 740 which are connected to a memory controller 720 through channels CH1, CH2, . . . , and CHn. Also, the semiconductor memory system 700 may simultaneously include an asynchronous flash memory device, a synchronous flash memory device, PRAM, MRAM, and FRAM. Further, some of the memory devices as shown in FIG. 7 may store normal data, and the remaining memory devices may store security data.

However, the present invention is not limited to this configuration. A semiconductor memory system according to an exemplary embodiment of the present invention may simultaneously include only some of the memory devices as shown in FIG. 1 to FIG. 6.

As described above, a memory system and a control method for the same according to an exemplary embodiment of the present invention can meet consumers' demands by combining different types of flash memory devices into one system.

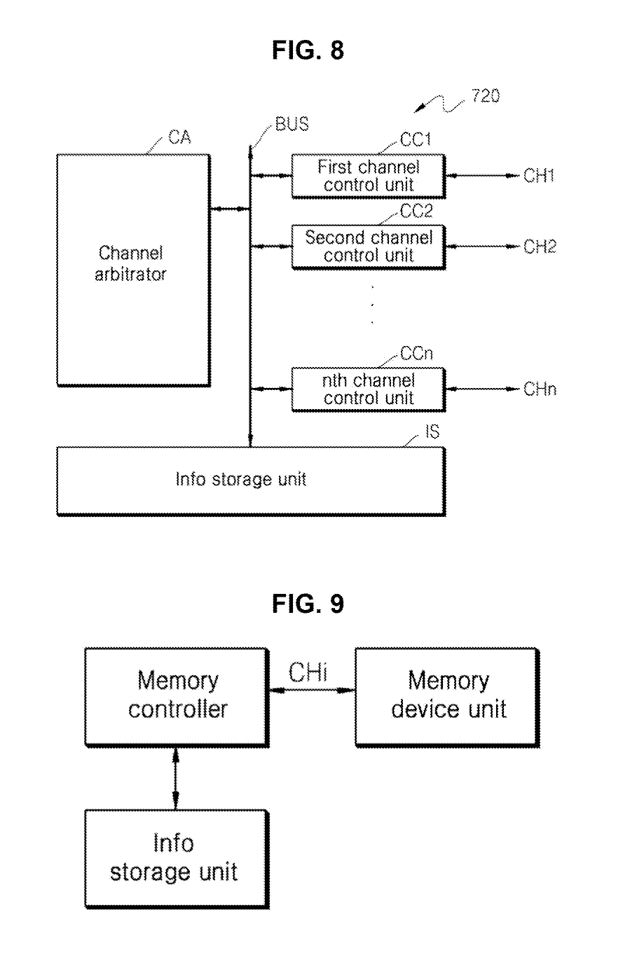

FIG. 8 is a block diagram showing the configuration of a memory controller shown in each of FIG. 1 to FIG. 7.

Referring to FIG. 8, a memory controller shown in FIG. 8 may be each of the memory controllers 120, 220, 320, 420, 520, 620 and 720, as shown in FIG. 1 to FIG. 7. However, hereinafter, for convenience of description, a description will be made of a case where a memory controller is limited to the memory controller shown in FIG. 7.

The memory controller 720 includes: channel control units CC1 to CCn for controlling corresponding channels independently of each other; a channel arbitrator CA which is connected to the channel control units CC1 to CCn through a bus and performs scheduling of the channel control units CC1 to CCn; and an information storage unit IS for storing information on memory devices connected to each channel and results of operations of the memory devices connected to each channel.

For example, the information storage unit IS may store control information depending on a difference in the number of programmed data bits (SLC/MLC), a manufacturer, the degree of integration, data characteristics (normal data/security data), the type of a memory device (flash/PRAM/MRAM/FRAM/RRAM), and whether memory devices are synchronized (synchronous/asynchronous), between the memory devices included in the semiconductor memory system.

Although the information storage unit IS is included in the memory controller as shown in FIG. 8, the present invention is not limited to this configuration. As shown in FIG. 9, the information storage unit IS may be located outside the memory controller. Further the information storage unit IS may store characteristic information of a bank of each memory device.

Referring back to FIG. 8, each of the channel control units CC1 to CCn receives information on memory devices (not shown) connected to a corresponding channel from the information storage unit IS, and controls an operation of programming the memory devices connected to the corresponding channel and an operation of reading data therefrom.

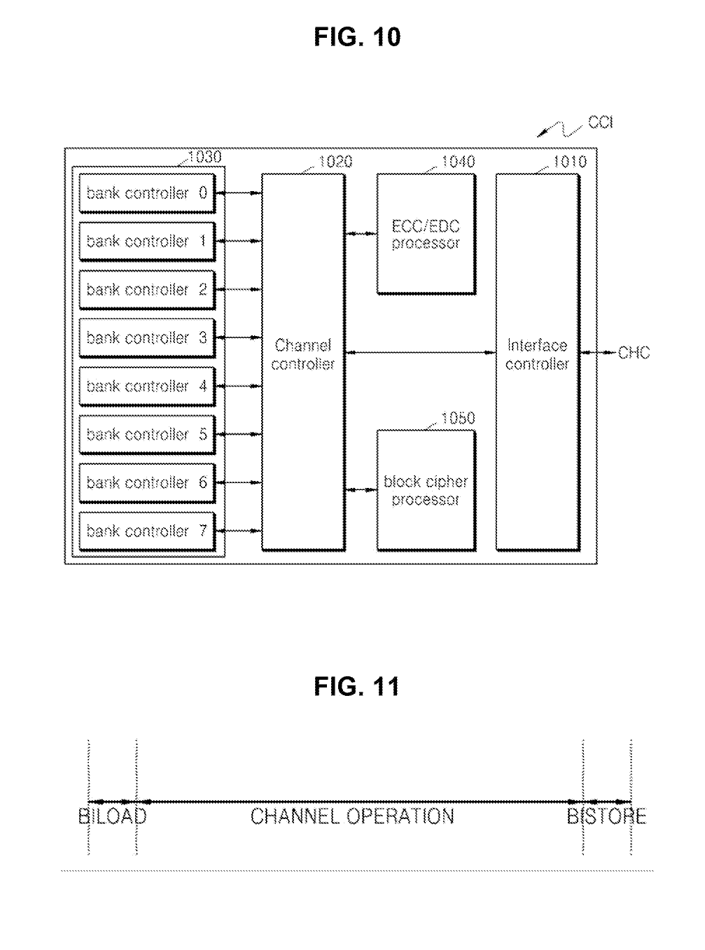

FIG. 10 is a block diagram showing a more detailed configuration of a channel control unit shown in FIG. 8.

Referring to FIG. 10, a channel control unit CCi (i is a natural number and 1≦i≦n) includes an interface controller 1010, a channel controller 1020, and block controllers 1030. The interface controller 1010 receives information on memory devices (not shown) connected to a corresponding channel from the information storage unit IS as shown in FIG. 8, and performs interfacing of data transmitted or received through the corresponding channel. The channel controller 1020 receives information on memory devices (not shown) connected to a corresponding channel from the information storage unit IS as shown in FIG. 8, and controls an operation of programming the memory devices connected to the corresponding channel and an operation of reading data therefrom. The channel controller 1020 performs the operation as described above, by performing control and scheduling of bank controllers (a bank controller 0 to a bank controller 7) for controlling each of banks of the memory devices.

For example, in response to control information received from the information storage unit IS, the channel control unit CCi as shown in FIG. 10 may perform a control operation so that one page address of one memory cell is generated and one program voltage or one readout voltage is applied to the one memory cell in a single-level cell flash memory device (SLC) connected to a corresponding channel. Otherwise, in response to control information received from the information storage unit IS, the channel control unit CCi as shown in FIG. 10 may perform a control operation so that two or more page addresses of one memory cell are generated and multiple program voltages or readout voltages are applied to the one memory cell in a multi-level cell flash memory device (MLC).

Continuously, referring to FIG. 10, the channel control unit CCi may further include an ECC/EDC (Error Correction Code/Error Detection Code) processor 1040 and a block encryption processor 1050. The ECC/EDC processor 1040 may receive information on memory devices from the information storage unit IS as shown in FIG. 8, and may perform ECC/EDC processing which adapts to a relevant memory device. The block encryption processor 1050 may receive information on memory devices from the information storage unit IS as shown in FIG. 8, and may perform block encryption which adapts to a relevant memory device.

FIG. 11 is a view for explaining the operation of the memory controller shown in FIG. 8.

Referring to FIG. 11, the memory controller first receives control information on an operation intended to be performed by a memory device connected to a corresponding channel (BI LOAD). The control information on the operation intended to be performed by the memory device may be provided by a host (not shown). Information received from the host may first be stored in the information storage unit IS, and may then be delivered to the channel control unit as shown in FIG. 8. The memory controller may receive information in the unit of bank of a memory device.

Based on the received information, the memory controller performs an operation of programming a memory device connected to an activated channel or an operation of reading data therefrom, and the like (CHANNEL OPERATION). Then, information on a result of the execution on a channel side is stored (BI STORE). The information on the result of the execution may be stored in the information storage unit IS, as described above.

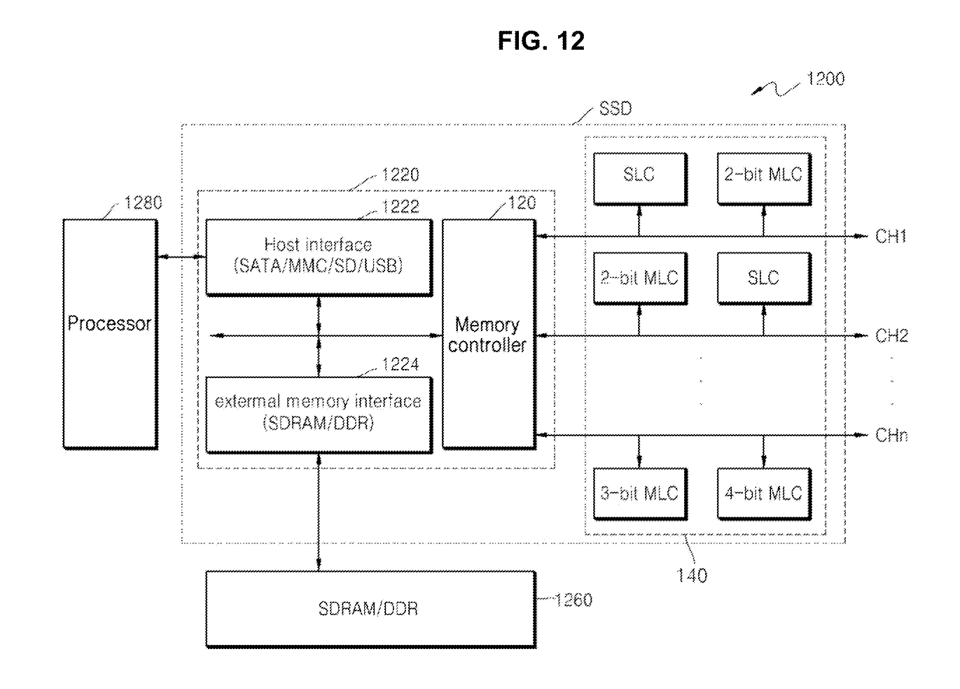

FIG. 12 is a block diagram showing the configuration of an SSD (Solid State Drive) and that of a computer system including the SSD, according to an exemplary embodiment of the present invention.

Referring to FIG. 12, an SSD according to an exemplary embodiment of the present invention may include the memory controller 120 and the flash memory devices 140, as shown in FIG. 1 and the like. However, the present invention is not limited to this configuration. The SSD may include the memory controller and the flash memory devices, as shown in each of FIG. 2 to FIG. 7. The memory controller 120 may be manufactured as a single chip 1220 together with a host interface 1222 for interfacing with a processor 1280 and an external memory interface 1224 for interfacing with an external memory 1260. The memory controller 120 programs data, which has been received through the host interface 1222 and the external memory interface 1224, into the flash memory devices 140. Also, the memory controller 120 transmits data, which has been read from the flash memory devices 140, to the processor 1280 and the external memory 1260 through the host interface 1222 and the external memory interface 1224.

A computer system 1200 according to an exemplary embodiment of the present invention includes the SSD as described above, the processor 1280, the memory controller 620, which is electrically connected to the bus 610, and the external memory 1260. Also, the computer system 1200 according to an exemplary embodiment of the present invention may further include a user interface (not shown), a power supply unit (not shown), etc.

As described above, exemplary embodiments have been disclosed in this specification and the accompanying drawings. Although specific terms are used herein, they are just used for describing the present invention, but do not limit the meanings and the scope of the present invention disclosed in the claims.

For example, although the semiconductor memory system as shown in FIG. 6 is shown as including only nonvolatile memory devices, the present invention is not limited to this configuration. The semiconductor memory system according to an exemplary embodiment of the present invention may simultaneously include a hybrid memory, a volatile memory and the like, together with a nonvolatile memory.

Accordingly, a person having ordinary knowledge in the technical field of the present invention will appreciate that various modifications and other equivalent embodiments can be derived from the exemplary embodiments of the present invention. Therefore, the scope of true technical protection of the present invention should be defined by the technical idea of the appended claims.

1. A semiconductor memory system, comprising:
multiple semiconductor memory devices;
an information storage unit for storing control information of each semiconductor memory device according to a difference between the multiple semiconductor memory devices; and
multiple channel control units each for controlling an operation of programming data or an operation of reading data into a semiconductor memory device connected to a corresponding channel according to control information received from the information storage unit.

2. The semiconductor memory system as claimed in claim 1, wherein the semiconductor memory devices correspond to NAND (NOT AND) flash memory devices.

3. The semiconductor memory system as claimed in claim 2, wherein the information storage unit stores control information depending on a difference in at least one of a manufacturer, a degree of integration, data characteristics (normal data/security data), and whether the semiconductor memory devices are synchronized, between the semiconductor memory devices.

4. The semiconductor memory system as claimed in claim 2, wherein the information storage unit includes control information depending on a difference in at least two of the number of bits of data programmed in a memory cell, a degree of integration, a manufacturer, whether the semiconductor memory devices are synchronized, and whether encrypted data is stored, between the semiconductor memory devices.

5. The semiconductor memory system as claimed in claim 2, wherein each of the multiple channel control units comprises:
an interface controller for performing interfacing of data transmitted or received through a corresponding channel according to the control information stored in the information storage unit; and
a channel controller for controlling the operation of programming the data into the semiconductor memory device connected to the corresponding channel, or the operation of reading the data therefrom, according to the control information received from the information storage unit.

6. The semiconductor memory system as claimed in claim 2, wherein the channel control unit stores a result of an operation performed for each corresponding channel in the information storage unit.

7. The semiconductor memory system as claimed in claim 2, wherein each of the channel control units performs error correction code/error detection code (ECC/EDC) processing, which adapts to the semiconductor memory device connected to the corresponding channel, according to the control information received from the information storage unit.

8. The semiconductor memory system as claimed in claim 3, wherein each of the multiple channel control units comprises:
an interface controller for performing interfacing of data transmitted or received through a corresponding channel according to the control information stored in the information storage unit; and
a channel controller for controlling the operation of programming the data into the semiconductor memory device connected to the corresponding channel, or the operation of reading the data therefrom, according to the control information received from the information storage unit.

9. The semiconductor memory system as claimed in claim 3, wherein the channel control unit stores a result of an operation performed for each corresponding channel in the information storage unit.

10. The semiconductor memory system as claimed in claim 3, wherein each of the channel control units performs error correction code/error detection code (ECC/EDC) processing, which adapts to the semiconductor memory device connected to the corresponding channel, according to the control information received from the information storage unit.

11. The semiconductor memory system as claimed in claim 4, wherein each of the multiple channel control units comprises:
an interface controller for performing interfacing of data transmitted or received through a corresponding channel according to the control information stored in the information storage unit; and
a channel controller for controlling the operation of programming the data into the semiconductor memory device connected to the corresponding channel, or the operation of reading the data therefrom, according to the control information received from the information storage unit.

12. The semiconductor memory system as claimed in claim 4, wherein the channel control unit stores a result of an operation performed for each corresponding channel in the information storage unit.

13. The semiconductor memory system as claimed in claim 4, wherein each of the channel control units performs error correction code/error detection code (ECC/EDC) processing, which adapts to the semiconductor memory device connected to the corresponding channel, according to the control information received from the information storage unit.
